(19) United States
(12) Patent Application Publication
(10) Pub. No.: US 2013/0000680 A1
(43) Pub. Date: Jan. 3, 2013

(54) CLEARING DRAIN PIPES

(76) Inventors: Kerry Dale Azelton, Pleasanton, CA (US); Stephen R. Dennis, Pleasanton, CA (US); Rashisa K. Khan, Pleasanton, CA (US)

(21) Appl. No.: 13/171,396

(22) Filed: Jun. 28, 2011

(51) Int. Cl. B08B 9/027

(52) U.S. Cl. 134/22.11; 134/166 C

(57) ABSTRACT

Described is a kit for clearing drain pipes. The kit may include a bottle having a reservoir containing drain-clearing composition and a neck extending from the reservoir. The neck may have a first engagement member. The kit also may include a drain-clearing tool formed of plastic and having a handle at one end, a flexible shaft extending from the handle for placement into a drain pipe, a ribbed surface extending along a length of the shaft for scouring a surface, and a plurality of longitudinally-spaced barbs covering a substantial portion of the length of the shaft. The bottle and drain-clearing tool may be assembled together, using a package, into a kit. The package may define an interior space to house the drain-clearing tool and/or a neck-receiving portion having a second engagement member that may complement the first engagement member of the neck of the bottle. Methods of using such kits are also disclosed.

### BACKGROUND

1. Field of the Invention

Embodiments of the present disclosure relate to a kit and a method for clearing debris from a drain pipe.

2. Description of the Related Art

Debris may be cleared from a drain pipe in a number of ways. A plunger may be used to create and alter a vacuum that may dislodge the debris from the drain pipe. A drain-clearing composition, in liquid or gel form, may be poured into the drain pipe to dissolve and/or disrupt debris so that it may be dislodged from the drain pipe. Or, a drain-clearing tool may be inserted into the drain pipe and used to mechanically disrupt and/or dislodge debris from the drain pipe.

Although each of these techniques may be suitable for various applications, there may be situations in which one or more of the techniques alone may be insufficient. For example, if a debris clog is particularly sturdy, drain clearing composition might not be strong enough to dissolve the debris sufficiently to dislodge it from the drain pipe. The composition may remain in the drain pipe at the clog for longer than anticipated, eroding and/or otherwise damaging the drain pipe. A sturdy clog may also be difficult to remove using a plunger. Some drains may be constructed in a manner that makes it difficult to form a seal with a plunger. If a debris clog is particularly far down a drain, then it may be difficult to reach with a drain-clearing tool.

### SUMMARY OF THE INVENTION

The present disclosure provides a kit for clearing drain pipes. The kit may include a bottle having a reservoir and a neck extending from the reservoir. The kit also may include a drain-clearing tool formed of plastic and having a handle at one end. A flexible shaft may extend from the handle of the drain-clearing tool for placement into a drain pipe. A ribbed surface may extend along a length of the shaft for scouring a surface. A plurality of longitudinally-spaced debris-engaging members such as barbs may cover a substantial portion of the length of the shaft. The kit also may include a package defining an interior space to house the drain-clearing tool and a neck-receiving portion. The present disclosure also provides a method of using the aforementioned kits.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 shows a perspective view of a kit for clearing a clogged drain pipe, in accordance with an embodiment of the present disclosure;

FIG. 2 shows a perspective view of a package to assemble together a bottle and a drain-clearing tool into a kit, in accordance with an embodiment of the present disclosure;

FIG. 3 shows a side view of the kit of FIG. 1, in accordance with an embodiment of the present disclosure, with a portion cut out to show interconnection of a plurality of ribs on a neck of the bottle and at least one complementary rib on the package;

FIGS. 4-8 show various views of the package of FIG. 2, in accordance with an embodiment of the present disclosure;

FIG. 9 shows a perspective view of bottle, in accordance with an embodiment of the present disclosure;

FIGS. 10-13 show various views of a drain-clearing tool, in accordance with one embodiment of the present disclosure;

FIGS. 14-17 show various views of a drain-clearing tool, in accordance with another embodiment of the present disclosure;

FIGS. 18-21 show various views of a drain-clearing tool, in accordance with yet another embodiment of the present disclosure;

FIG. 22 shows a view of a drain-clearing tool, in accordance with yet another embodiment of the disclosure, with a ribbed surface extending along an entire length of a shaft of the drain-clearing tool; and

FIGS. 23-28 depict one embodiment of a kit being used to clear debris from a drain.

### DETAILED DESCRIPTION OF EMBODIMENTS

Reference will now be made to the drawings wherein like numerals refer to like parts throughout. For ease of description, the components of embodiments of the present invention are described in the normal (upright) operating position, and terms such as upper, lower, horizontal, etc., are used with reference to this position. It will be understood, however, that the components of embodiments of the present invention may be manufactured, stored, transported, used, and sold in an orientation other than the position described.

Figures illustrating the components of embodiments of the present invention show some conventional mechanical elements that may be known and that may be recognized by one skilled in the art. The detailed descriptions of such elements that are not necessary to an understanding of the invention, and accordingly are herein presented only to the degree necessary to facilitate an understanding of the novel features of the present invention.

As used herein and in the appended claims, the term “comprising” is inclusive or open-ended and does not exclude additional unrecited elements, compositional components, or method steps. Accordingly, the term “comprising” encompasses the more restrictive terms “consisting essentially of” and “consisting of.”

It must be noted that, as used in this specification and the appended claims, the singular forms “a,” “an,” and “the” include plural references unless the content clearly dictates otherwise. Similarly, the use of substantially any plural terms herein may be translated by those having skill in the art from the plural to the singular as is appropriate to the context and/or application. The various singular/plural permutations may be expressly set forth herein for sake of clarity.

In those instances where a convention analogous to “at least one of A, B, and C, etc.” is used, in general such a construction is intended in the sense one having skill in the art would understand the convention (e.g., “an apparatus having at least one of A, B, and C” would include but not be limited to apparatuses that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 elements refers to groups having 1, 2, or 3 elements. Similarly, a group having 1-5 elements refers to groups having 1, 2, 3, 4, or 5 elements, and so forth.

Unless defined otherwise, all technical and scientific terms used herein have the same meaning as commonly understood by one of ordinary skill in the art to which embodiments of the present invention pertain. Although a number of methods and materials similar or equivalent to those described herein can be used in the practice of the present invention, the preferred materials and methods are described herein.

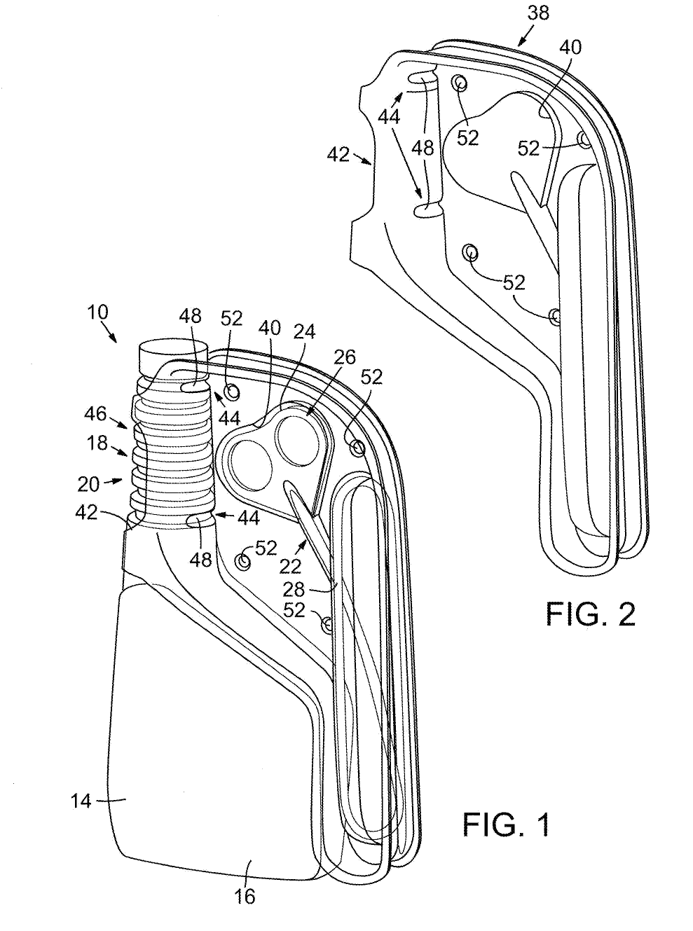

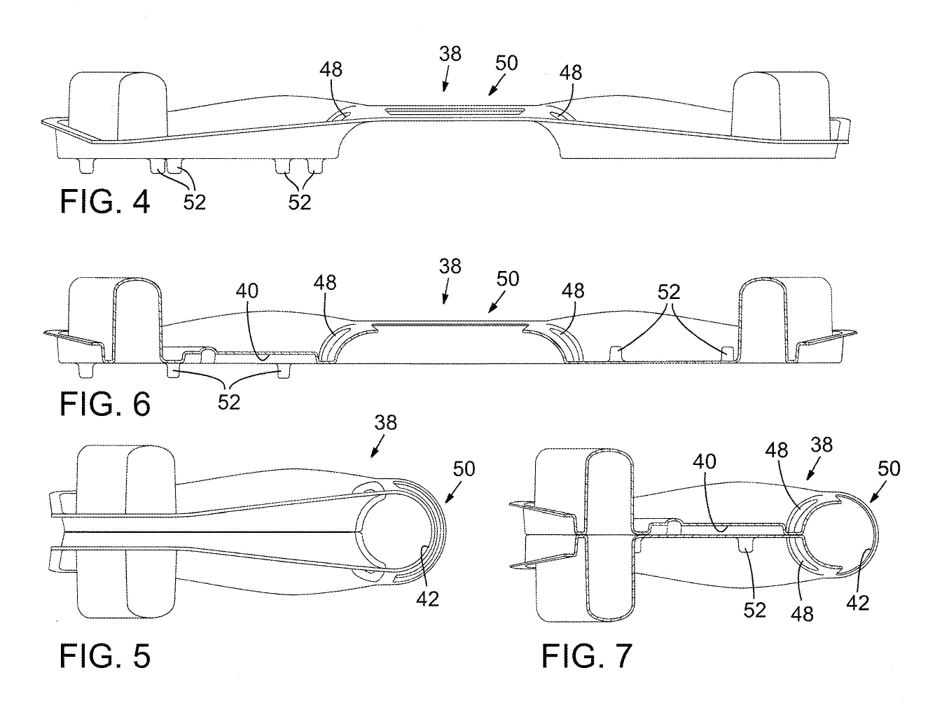

Referring primarily to FIGS. 1 and 3, there are shown views of an example kit 10 for clearing drain pipes in accordance with various embodiments of the present disclosure. Kit 10 includes a bottle 14 having a reservoir 16 and a neck 18 extending from reservoir 16. Neck 18 includes a first engagement member 20 that may include an engagement member that engages a complementary engagement member on a package, as will be described below.

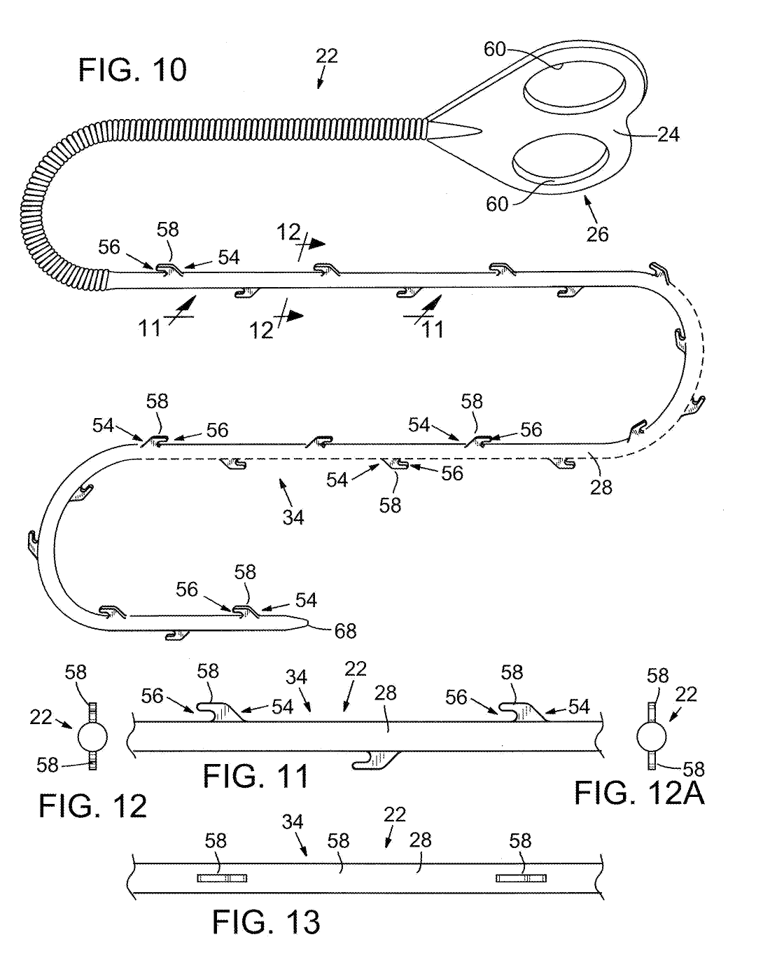

Kit 10 also includes a drain-clearing tool 22, which may be formed of plastic or of other materials. Drain-clearing tool 22 may include a handle 24 at a proximal end 26. Drain-clearing tool 22 may include a flexible shaft 28 extending from handle 24 for placement into a drain pipe. As shown in FIGS. 10-28, a ribbed surface 30 may extend along a length of shaft 28 for scouring a surface, such as a surface of a clog of debris or an interior surface of a pipe. Drain-clearing tool may include a plurality of longitudinally-spaced debris-engaging members such as barbs 34 covering a substantial portion of the length of the shaft 28.

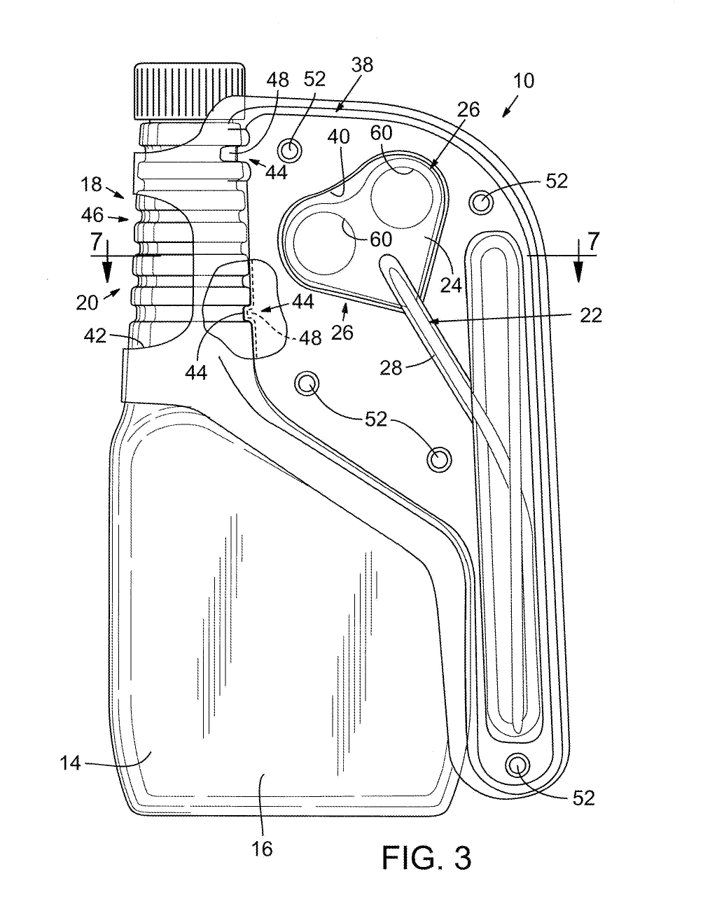

Referring to FIGS. 1-8, a package 38 may be provided for assembling bottle 14 and drain-clearing tool 22 together into kit 10 for distribution and sale. Package 38 may be constructed of various suitable materials, such as plastic, and may in some embodiments be transparent or translucent to provide at least some visibility of its contents.

Package 38 may define an interior space 40 to house drain-clearing tool 22 and a neck-receiving portion 42 having a second engagement member 44 that compliments first engagement member 20 on neck 18 of bottle 14. In some embodiments, package 38 may leave the reservoir and/or a portion of the neck visible to a user and/or exposed.

As seen best in FIG. 3, first engagement member 20 may include an engagement member such as a plurality of ribs 46, and second engagement member 44 may include a complementary engagement member, such as at least one complementary rib 48 adapted to extend between two or more of the plurality of ribs 46 of first engagement member 20, to secure bottle 14 with respect to package 38. While complementary ribs 46 and 48 are shown, this is not meant to be limiting, and any pair of complementary engagement members may be distributed on neck 18 and neck-receiving portion 42 in order to secure bottle 14 to package 38.

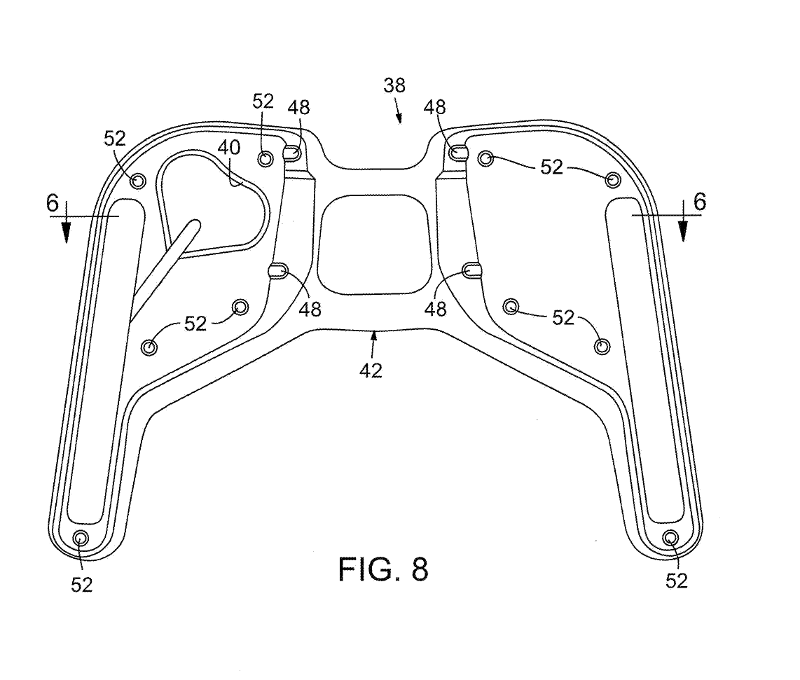

In some embodiments, such as those shown in FIGS. 4-8, package 38 may be constructed out of two halves, connected to one another via a hinged connection 50. When package 38 is used to assemble bottle 14 and drain-clearing tool 22 into kit 10, the two halves of package 38 may be closed around bottle 14 and drain-clearing tool 22. In some embodiments, complementary connectors 52 may be provided on each half of package 38 so that when package 38 is closed, complementary connectors 52 may fit (or “snap”) into each other. Conversely, the two halves of package 38 may be opened by disconnecting complementary connectors 52 so that bottle 14 and drain-clearing tool 22 may be removed from package 38.

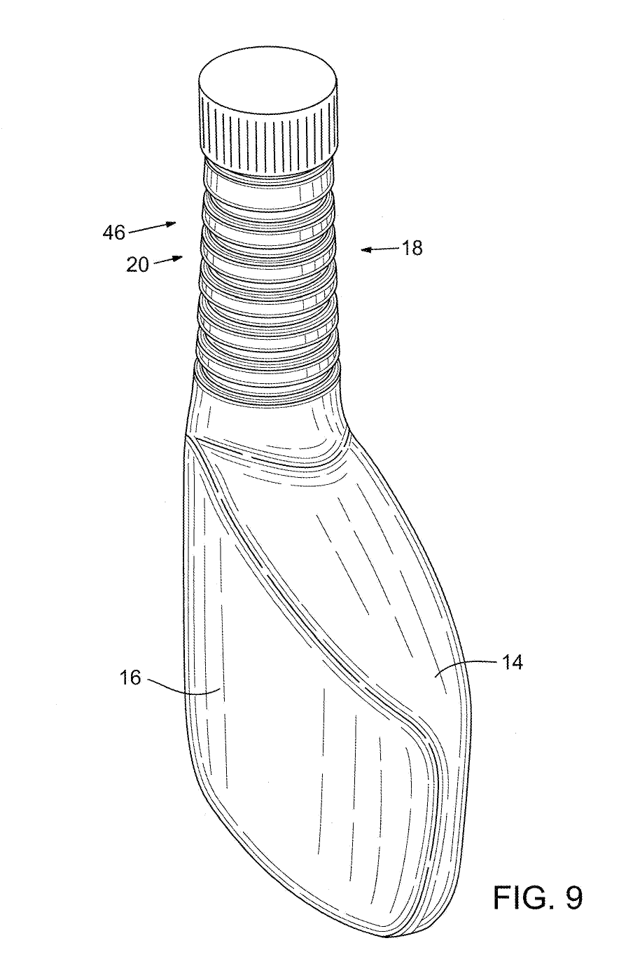

FIG. 9 depicts bottle 14 according to some embodiments. Bottle 14 may be constructed from various materials such as plastic in order to hold a drain-clearing composition. The drain-clearing composition may, in some embodiments, be in liquid, gel or granular form.

Referring now to FIGS. 10-28, drain-clearing tool 22 may include various features for assisting with the dislodging and removal of debris from drain pipes. For example, as noted above drain-clearing tool 22 may include plurality of longitudinally-spaced barbs 34. These barbs 34 may come in various shapes and sizes. For example, in the embodiments shown in FIGS. 10-17 and 22, plurality of longitudinally-spaced barbs 34 each include a first side 54 facing away from handle 24, the first side 54 extending from shaft 28 at a substantially perpendicular angle.

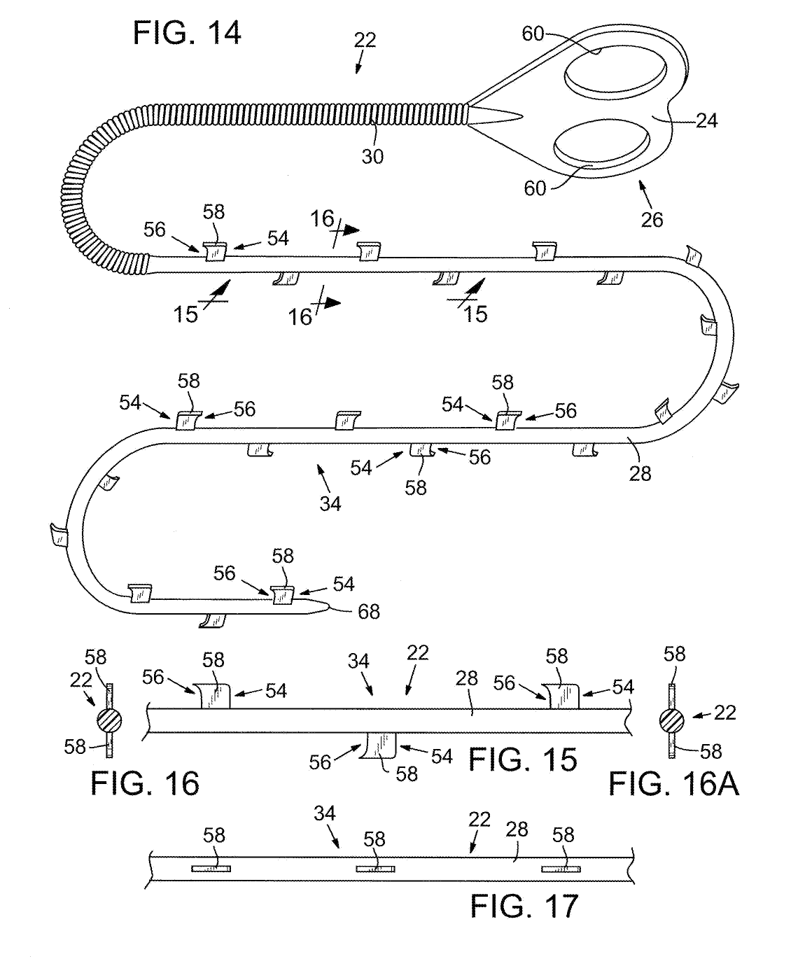

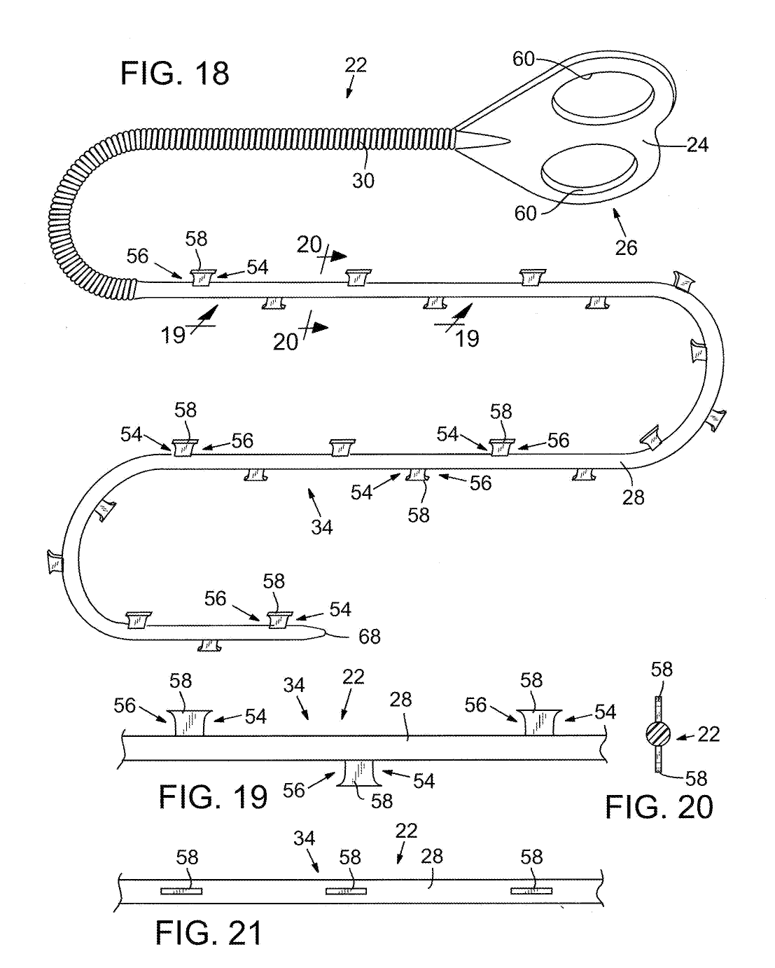

A second side 56 of each barb, opposite the first side 54 and facing handle 24, connects a terminal end 58 of the barb to shaft 28 and may be curved. In the three drain-clearing tool embodiments shown in FIGS. 10-21, end 58 of each barb extends substantially parallel to the length of shaft 28. In FIGS. 10-13 and 22, the second side 56 has a curve that is convex, giving each barb an appearance similar to a branch of a saguaro cactus. In FIGS. 14-21, second side 56 of each barb facing handle 24 is curved and concave. In the embodiment shown in FIGS. 18-21, first side 54 of each barb facing away from handle 24 is also curved, so that an apex of the curve points towards handle 24, which allows for engagement of debris in both directions as the operator moves the drain-clearing tool into and out of a drain pipe.

The plurality of longitudinally-spaced barbs 34 may be used to disrupt, dislodge and/or capture debris clogging a drain in various ways, as will he discussed below. The curved shape of the second side 56 of each barb facing handle 24 may assist in capturing debris. For example, the concave, cactus branch shape of the barbs of the embodiments shown in FIGS. 10-13 and 22 may be suitable for capturing strands of debris such as hair, particularly as drain-clearing tool 22 is withdrawn from a drain. The convex curved shape of the barbs of FIGS. 14-21 may be suitable for other purposes, such as cutting through debris or capturing larger fragments of debris.

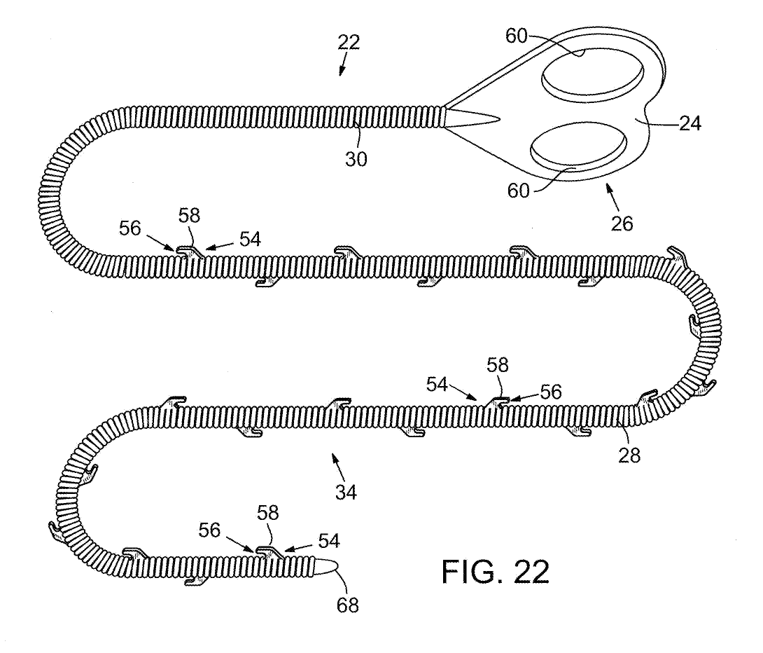

In addition to barbs, drain-clearing tools 22 of the present disclosure may include ribbed surface 30 extending along some portion or all of the length of shaft 28. For example, in the embodiments shown in FIGS. 10-21, ribbed surface 30 extends approximately one third of the way along the length of shaft 28 of drain-clearing tool 22. In other embodiments, ribbed surface 30 may extend over at least a portion of the length of the shaft 28 that includes the barbs 34. For example, in the embodiment of FIG. 22, ribbed surface 30 extends over substantially the entire length of shaft 28 of drain-clearing tool 22. In other embodiments, ribbed surface 30 may extend other lengths along shaft 28. As will be discussed below, drain-clearing tool 22 may be moved back and forth so that ribbed surface 30 scours various other surfaces of a drain pipe or debris.

As best seen in FIGS. 10, 14, 18 and 22, handle 24 of drain-clearing tool 22 may include two or more apertures 60. By inserting two fingers into the apertures, a user may operate handle 24 to maneuver drain-clearing tool 22 in various ways. For example, by virtue of the insertion of two fingers, the user may twist drain-clearing tool 22 with a greater amount of torque than would be possible without the apertures. And twisting drain-clearing tool 22, particularly when using embodiments such as those shown in FIGS. 14-21, may assist in disrupting and/or dislodging debris from a drain pipe.

Additionally, if debris is captured on second side 56 of each barb (particularly the cactus branch shape barbs of FIGS. 10-13 and 22, a relatively large amount of force may be necessary to dislodge or disrupt the debris in the drain pipe and withdraw drain-clearing tool 22. However, with fingers inserted through apertures 60 of handle 24, a user may he able to pull up with much greater force than if handle 24 had no apertures.

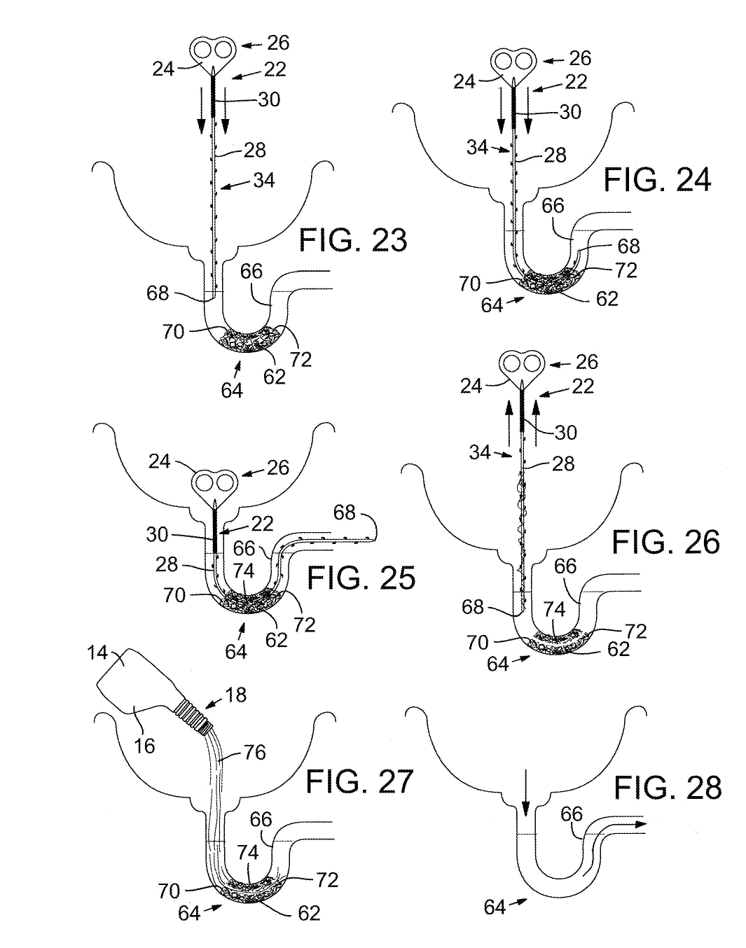

An exemplary method of using kit 10 to remove debris 62 from a trap 64 of a drain pipe 66 in accordance with various embodiments is shown in FIGS. 23-28. In FIG. 23, shaft 28 of drain-clearing tool 22 is inserted into drain pipe 66 until a distal end 68 of shaft 28 opposite proximal end 26 is adjacent debris 62. As shown in FIGS. 24 and 25, handle 24 may be operated (e.g., with fingers inserted through apertures 60) to push distal end 68 of shaft 28 into a proximal periphery 70 of debris 62 until at least distal end 68 emerges from a distal periphery 72 of debris 62.

As shown in FIG. 26, handle 24 may then be operated to withdraw shaft 28 from debris 62 and drain pipe 66, leaving a channel 74 through debris 62 from proximal periphery 70 through to distal periphery 72 of debris 26. At FIG. 27, drain-clearing composition 76 may be poured from bottle 14 into drain pipe 66 so that composition 76 enters channel 74 through debris 62, thereby disrupting (e.g., dissolving) debris 62 from within channel 74. Handle 24 may also be operated to repeatedly insert (e.g., FIG. 24) and withdraw (e.g., FIG. 26) drain-clearing tool 22, which may scour inner surfaces of channel 74 through debris 62 using ribbed surface 30 of shaft 28. This scouring may assist in disrupting and/or dislodging debris 62 from trap 64 of drain pipe 66.

Repeatedly inserting and withdrawing drain-clearing tool 22 also may cause second sides 56 of the plurality of longitudinally-spaced barbs 34 facing handle 24 to capture debris as shaft 28 is withdrawn. It may additionally or alternatively cause first sides 54 of the plurality of longitudinally-spaced barbs 34 facing away from handle 24 to break apart debris 62 as shaft 28 is advanced. In some embodiments, such as those shown in FIGS. 18-21, barbs of drain-clearing tool 22 engage debris 62 in both directions. In other embodiments, such as those shown in FIGS. 10-17 and 22, barbs of drain-clearing tool 22 permit drain-clearing tool 22 to slide into the debris, particularly where the debris is largely fibrous, as may be the case as debris often includes hair.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the appended claims.

What is claimed is:

1. A kit for clearing a drain pipe comprising:
a bottle having a reservoir and a neck extending from the reservoir;
a drain-clearing tool formed of plastic and having a handle at one end, a flexible shaft extending from the handle for placement into a drain pipe, a ribbed surface extending along a length of the shaft for scouring a surface, and a plurality of longitudinally-spaced barbs covering a substantial portion of the length of the shaft; and
a package defining an interior space to house the drain-clearing tool and a neck-receiving portion.

2. The kit for clearing a drain pipe of claim 1, wherein the neck includes a first engagement member and the neck-receiving portion includes a second, complementary engagement member that engages the first engagement member of the neck of the bottle.

3. The kit for clearing a drain pipe of claim 1, wherein a side of each barb of the plurality of longitudinally-spaced barbs facing away from the handle extends from the shaft at a substantially perpendicular angle.

4. The kit for clearing a drain pipe of claim 1, wherein each barb of the plurality of longitudinally-spaced barbs terminates in an end that extends substantially parallel to the length of the shaft.

5. The kit for clearing a drain pipe of claim 4, wherein a side of each barb of the plurality of longitudinally-spaced barbs facing the handle and connecting the end of the barb to the shaft is curved.

6. The kit for clearing a drain pipe of claim 5, wherein the curved side of each barb facing the handle is convex.

7. The kit for clearing a drain pipe of claim 5, wherein the curved side of each barb facing the handle is concave.

8. The kit for clearing a drain pipe of claim 1, wherein a side of each barb of the plurality of longitudinally-spaced barbs facing away from the handle is curved so that an apex of the side curve points towards the handle.

9. The kit for clearing a drain pipe of claim 1, wherein the first engagement member includes a plurality of ribs, and the second engagement member includes at least one complementary rib adapted to extend between two or more of the plurality of ribs of the first engagement member to secure the bottle with respect to the package.

10. The kit for clearing a drain pipe of claim 1, wherein the package is transparent.

11. The kit for clearing a drain pipe of claim 1, wherein the ribbed surface extends over at least a third of the length of the shaft of the drain-clearing tool.

12. The kit for clearing a drain pipe of claim 9, wherein the ribbed surface extends over at least a portion of the length of the shaft of the drain-clearing tool that includes the barbs.

13. The kit for clearing a drain pipe of claim 10, wherein the ribbed surface extends over substantially the entire length of the shaft of the drain-clearing tool.

14. The kit for clearing a drain pipe of claim 1, wherein the handle defines two apertures to receive two of an operator's fingers.

15. The kit for clearing a drain pipe of claim 1, wherein the package leaves at least the reservoir visible.

16. The kit for clearing a drain pipe of claim 15, wherein the package leaves at least the reservoir exposed.

17. A method of clearing a drain pipe of debris, comprising:
inserting a shaft of a drain-clearing tool into the drain pipe until a distal end of the shaft is adjacent the debris;
operating a handle of the drain-clearing tool to push the distal end of the shaft into a proximal periphery of the debris until at least the distal end emerges from a distal periphery of the debris;
operating the handle of the drain-clearing tool to withdraw the shaft from the debris and the drain pipe, leaving a channel through the debris from the proximal periphery to the distal periphery; and
pouring a drain-clearing composition into the drain so that the composition enters the channel through the debris and disrupts the debris from within the channel.

18. The method of claim 17, further comprising operating the handle of the drain-clearing tool to scour inner surfaces of the channel through the debris with a ribbed surface of the shaft of the drain-clearing tool.

19. The method of claim 17, further comprising operating the handle of the drain-clearing tool to break up the debris with a plurality of longitudinally-spaced barbs covering a substantial portion of a length of the shaft.

20. The method of claim 19, further comprising applying torque to the handle of the drain-clearing tool to rotate the shaft about a longitudinal axis of the shaft, so that sides of the plurality of longitudinally-spaced barbs break apart the debris.

21. The method of claim 19, further comprising repeatedly pushing and pulling the handle of the drain-clearing tool to advance and withdraw, respectively, the shaft of the drain-clearing tool so that sides of the plurality of longitudinally-spaced barbs facing the handle capture debris as the shaft is withdrawn, and so that sides of the plurality of longitudinally-spaced barbs facing away from the handle break apart the debris as the shaft is advanced.

22. The method of claim 17, wherein the shaft of the drain-clearing tool is withdrawn from the drain pipe entirely before the drain-clearing composition is poured into the drain.

23. A drain-clearing tool, comprising:
a flexible shaft, constructed of plastic, for placement into a drain pipe, the flexible shaft having a handle at one end, the handle defining two apertures to receive two of an operator's fingers;
a ribbed surface extending along a length of the shaft for scouring a surface; and
a plurality of longitudinally-spaced barbs covering a substantial portion of the length of the shaft.

24. The tool of claim 23, wherein the ribbed surface extends over at least a portion of the length of the shaft that includes the barbs.

25. A kit for clearing a drain pipe comprising:
a bottle having a reservoir and a neck extending from the reservoir;
a drain-clearing tool formed of plastic and having a handle at one end, a flexible shaft extending from the handle for placement into a drain pipe, a ribbed surface extending along a length of the shaft for scouring a surface, and a plurality of debris-engaging members spaced along of the shaft; and
a package for assembling the bottle and the drain-clearing tool into the kit, the package including a first engagement member that engages a complementary second engagement member on the neck, wherein the package leaves at least the reservoir visible.

26. The kit of claim 25, wherein the package leaves at least the reservoir exposed.
